(19) United States
(12) Patent Application Publication
(10) Pub. No.: US 2011/0007053 A1
(43) Pub. Date: Jan. 13, 2011

(54) DISPLAY PANEL, DISPLAY DRIVING APPARATUS, DISPLAY APPARATUS, METHOD FOR ARRANGING ELECTRODES

(75) Inventor: Chan-young JO, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/731,541

(22) Filed: Mar. 25, 2010

(30) Foreign Application Priority Data
Jul. 9, 2009 (KR) 10-2009-0062626

(51) Int. Cl. G06F 3/038; G09G 3/20

(52) U.S. Cl. 345/211; 345/55

(57) ABSTRACT

A display panel having an electrode structure that reduces electromagnetic interference (EMI) emission, a display driving unit, a display apparatus, and a method for arranging electrodes are provided. A display panel includes a plurality of pixels, and an electrode disposed on the plurality of pixels in a first direction and a second direction in an alternating manner. Accordingly, emission level of EMI generated by a discharge electrode of a plasma display panel (PDP) can be reduced.

### CROSS-REFERENCE TO RELATED APPLICATIONS

This application claims priority from Korean Patent Application No. 10-2009-0062626, filed on Jul. 9, 2009 in the Korean Intellectual Property Office, the disclosure of which is incorporated herein by reference in its entirety.

### BACKGROUND

1. Field

Apparatuses and methods consistent with the inventive concept relate to a display panel, a display driving unit, a display apparatus, and a method for arranging electrodes, and more particularly, to a display panel having structure of electrodes that reduces electromagnetic interference (EMI) emission, a display driving unit, a display apparatus, and a method for arranging electrodes.

2. Description of the Related Art

Flat panel displays are broadly applied to portable devices and are widespread. In a large-display device field, conventional cathode ray tube (CRT) displays are rapidly replaced with flat panel displays.

Among flat panel displays, a plasma display panel (PDP) is a type of flat panel display which shows text or graphics using light emitted from plasma generated upon discharging gas. The PDP has luminance and light emitting efficiency higher than other flat panel displays, and is thus widespread these days.

One of the shortcomings of the PDP is that electromagnetic interference (EMI) may occur due to generation of electromagnetic wave noise while the PDP is operating. That is, since high voltage of approximately 200V and root mean square (RMS) current higher than 2A are applied to the electrodes constituting a PDP, EMI is emitted by using the electrodes of the PDP as antenna.

One cause of EMI is that the electrodes on the panel are formed in a long and linear shape. Therefore, there is a need for methods to reduce EMI emission by changing the configuration of the electrodes.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

One or more exemplary embodiments provide a display panel having electrodes structured so as to reduce electromagnetic interference (EMI) emission, a display driving unit, a display apparatus, and a method for arranging electrodes.

According to an exemplary embodiment, there is provided a display panel including a plurality of pixels, and an electrode disposed on at least one of the plurality of pixels in a first direction and a second direction in an alternating manner.

The electrode may be formed on pixels constituting a same row or a same column from among the plurality of pixels.

In the electrode, there may be a plurality of portions formed in the first direction, and a plurality of portions formed in the second direction, and in the electrode, a direction of an electric current may be the same in the portions formed in the first direction, and a direction of an electric current may be alternately opposite in the portions formed in the second direction.

The electrode may go through an inside of the at least one pixel in the first direction, or go through a boundary of the at least one pixel in the second direction.

A portion of the electrode which is formed in the inside of the at least one pixel may be used for plasma discharge in the at least one pixel, and a portion of the electrode which is formed in the boundary of the at least one pixel may be used to reduce electromagnetic interference (EMI) emission in the at least one pixel.

The electrode may include at least one of an X electrode, a Y electrode, and an address electrode. If the electrode is an X electrode or a Y electrode, the first direction may be a row direction of the plurality of pixels, and the second direction may be a column direction of the plurality of pixels. If the electrode is an address electrode, the first direction may be a column direction of the plurality of pixels, and the second direction may be a row direction of the plurality of pixels.

The electrode may include an X electrode and a Y electrode. A portion of the X electrode and a portion of the Y electrode may have different heights with reference to a plane in which the plurality of pixels are located.

The electrode may include an X electrode, a Y electrode, an indium tin oxide (ITO) electrode connected to the X electrode, and an ITO electrode connected to the Y electrode. The ITO electrode connected to the X electrode and the ITO electrode connected to the Y electrode may have the same height with reference to a plane on which the plurality of pixels are located.

The electrode may include an X electrode or a Y electrode. The number of portions of the X electrode or the Y electrode which are formed in the first direction is equal to the number of rows of the plurality of pixels.

The electrode may include at least one of an X electrode, a Y electrode, and an address electrode. The number of X electrodes or Y electrodes may equal the number of rows of the plurality of pixels. The number of address electrodes may equal the number of columns of the plurality of pixels.

The electrode may include an X electrode and a Y electrode. The X electrode and the Y electrode may face each other in an inside of each pixel with reference to a discharging space of each pixel.

The electrode may include an X electrode or a Y electrode. If one of the X electrode and the Y electrode is formed on one of two areas which are divided with reference to a discharging space of each pixel, the other one of the X electrode and the Y electrode may be formed on the other one of the two areas.

According to another exemplary embodiment, there is provided a display panel, including a plurality of pixels, and an electrode which goes through an inside and a boundary of at least one of the plurality of pixels.

According to another exemplary embodiment, there is provided a display panel, including a plurality of pixels, and an electrode which is formed on the plurality of pixels in a prominence and depression structure.

According to another exemplary embodiment, there is provided a display driving apparatus, including a display panel which comprises an electrode which is formed on at least one of a plurality of pixels in a first direction and a second direction in an alternating manner, and a driving unit which drives the display panel so that plasma discharge can be performed in the plurality of pixels.

According to another exemplary embodiment, there is provided a display apparatus, including a display panel which comprises an electrode which is formed on at least one of a plurality of pixels in a first direction and a second direction in an alternating manner, and a control unit which controls driving of the display panel so that plasma discharge can be performed in the plurality of pixels.

According to another exemplary embodiment, there is provided a method for driving a display, the method including arranging an electrode so that a portion of the electrode is formed on an inside of a first side of at least one of a plurality of pixels provided on the display in a first direction, and the remaining portion of the electrode is formed on a boundary of a second side of the at least one pixel in a second direction perpendicular to the first direction, and driving the display by flowing an electric current into the electrode.

### BRIEF DESCRIPTION OF THE DRAWINGS

The above and/or other aspects will be more apparent by describing certain exemplary embodiments with reference to the accompanying drawings, in which:

FIG. 1 is a block diagram of a display apparatus according to an exemplary embodiment;

FIG. 2 is a schematic plane view of a display driving apparatus according to an exemplary embodiment;

FIGS. 3A and 3B illustrate the form of an X electrode and a Y electrode according to an exemplary embodiment;

FIGS. 4A and 4B illustrate an internal structure of a pixel;

FIGS. 5A to 5D illustrate the forms of an X electrode according to diverse exemplary embodiments;

FIGS. 6A to 6C illustrate the forms of an address electrode according to diverse exemplary embodiments; and

FIG. 7 is a flow chart illustrating a method for operating a display according to an exemplary embodiment.

### DETAILED DESCRIPTION OF EXEMPLARY EMBODIMENTS

Certain exemplary embodiments will now be described in greater detail with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, the exemplary embodiments can be practiced without those specifically defined matters. Also, well-known functions or constructions are not described in detail since they would obscure the exemplary embodiments with unnecessary detail. Expressions such as “at least one of,” when preceding a list of elements modifies the entire list of elements and does not modify each element of the list.

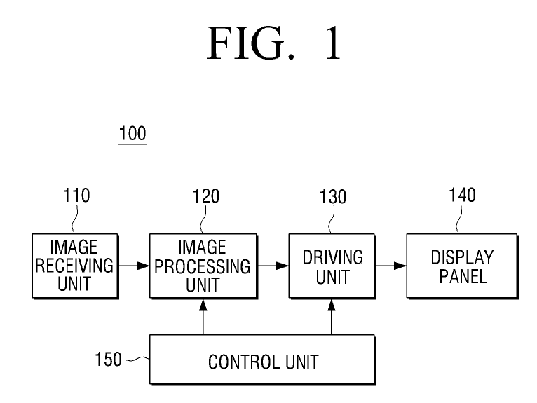

FIG. 1 is a block diagram of a display apparatus 100 according to an exemplary embodiment.

The display apparatus 100 provides a viewer with viewable images.

As illustrated in FIG. 1, the display apparatus 100 may include an image receiving unit 110, an image processing unit 120, a driving unit 130, a display panel 140, and a control unit 150.

The image receiving unit 110 receives an image signal wirelessly or through a cable, and transmits the image signal to the image processing unit 120.

The image processing unit 120 processes the image signal received from the image receiving unit 110. More specifically, the image processing unit 120 decodes the image signal, converts the decoded image signal into an image signal of an output format by color signal processing and scaling, and transmits the image signal in the output format to the driving unit 130.

The driving unit 130 receives the image signal in the output format, and drives the display panel 140 to display the image signal. The display panel 140 is driven by the driving unit 130 and provides the viewer with the viewable image.

The control unit 150 controls the overall operation of the display apparatus 100.

In particular, the control unit 150 controls the image processing unit 120 to process the received image signal.

In addition, the control unit 150 transmits an X electrode driving control signal, a Y electrode driving control signal, and an address electrode driving control signal to the driving unit 130 so that the driving unit 130 can drive the display panel 140. The driving unit 130 drives the display panel 140 based on the received X electrode driving control signal, Y electrode driving control signal, and address electrode driving control signal.

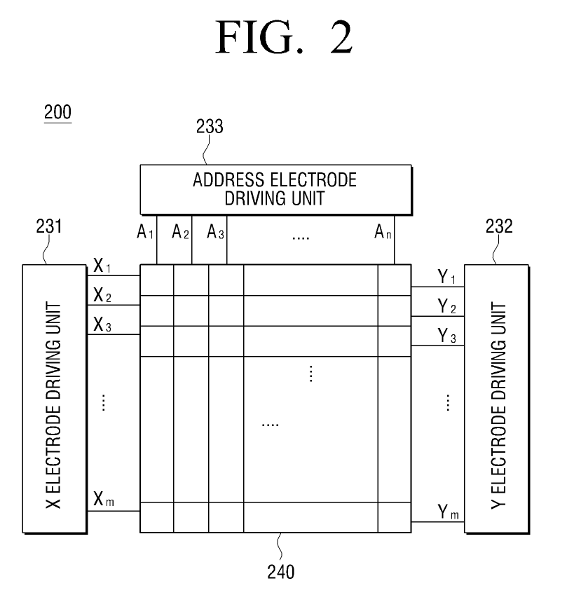

FIG. 2 is a schematic plane view of the display driving apparatus 200 according to an exemplary embodiment. The display driving apparatus 200 may include an X electrode driving unit 231, a Y electrode driving unit 232, and an address electrode driving unit 233, and a display panel 240.

The X electrode driving unit 231 receives an X electrode driving control signal from the control unit 150, and applies a driving voltage to each X electrode. The Y electrode driving unit 232 receives a Y electrode driving control signal from the control unit 150, and applies a driving voltage to each Y electrode. In particular, the X electrode driving unit 231 and the Y electrode driving unit 232 perform sustained discharge for a selected pixel by alternately inputting a sustained voltage to the X electrode and the Y electrode, respectively.

The address driving unit 233 applies a data signal to each address electrode to select a pixel to be displayed. The X electrodes are at right angles to the address electrodes, and the Y electrodes are at right angles to the address electrodes. The X electrodes face the Y electrodes, and a discharging space is formed between adjacent X and Y electrodes. The discharging space in which the address electrodes, the X electrodes and the Y electrodes cross each other forms discharging cells.

The display panel 240 has a structure that a plurality of pixels are arranged in a matrix form. The X electrode, the Y electrode, and the address electrode are formed on each pixel of the display panel 240. Accordingly, the display panel 240 operates in an address display separate (ADS) operating method in which voltage is applied to each electrode to emit light from each pixel. In the ADS operating method, each subfield of the display panel 240 is divided into a reset section, an address section, and a sustain discharge section.

The reset section erases a wall charge state and sets up the wall charge to stably perform address discharge. The address section selects turned-on cells and turned-off cells on the display panel 240, and accumulates the wall discharge in the turned-on cells (addressed cells). The sustain discharge section applies a sustained voltage to the X electrodes and the Y electrodes alternately, and performs discharge to display an image on addressed cells.

The display panel 240 generates discharge using a difference between voltage applied from the X electrodes and voltage applied from the Y electrodes, and operates by emitting light due to generation of the discharge.

In FIGS. 1 and 2, different reference numbers are used for the same element, but this is merely for convenience of description. That is, the driving unit 130 in FIG. 1 may be replaced with combination of the X electrode driving unit 231, the Y electrode driving unit 232, and the address electrode driving unit 233, and the display panel 140 in FIG. 1 may be replaced with the display panel 240 in FIG. 2.

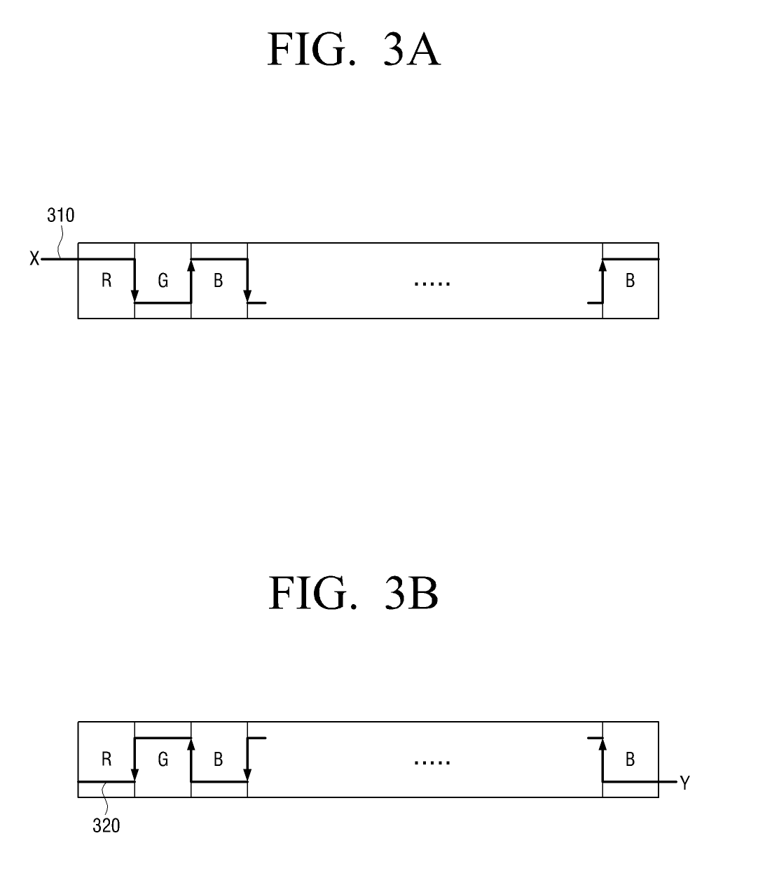

Hereinafter, the form of the electrodes to reduce electromagnetic interference (EMI) generated when discharge is generated on the display panel 240 is described with reference to FIGS. 3A and 3B.

FIGS. 3A and 3B illustrate the form of an X electrode and a Y electrode according to an exemplary embodiment. In FIGS. 3A and 3B, pixels corresponding to a single row from among the plurality of pixels in the display panel 240 are illustrated.

As illustrated in FIG. 3A, an X electrode 310 horizontally goes (i.e., is disposed) through the pixels in a single row on the whole. In detail, a pattern that the X electrode 310 horizontally goes through the inside of each pixel, and vertically goes through the boundary of each pixel is repeated, thereby forming a prominence and depression structure.

As described above, the X electrode 310 faces the Y electrode 320, with a discharging space therebetween, and plasma discharge is performed by discharge of the discharging space. Among the X electrode 310, a portion formed inside each pixel is disposed to face the Y electrode 320 of FIG. 3B, with a discharging space therebetween, and is used for plasma discharge.

Among the X electrode 310, a portion formed on the boundary of each pixel is used to reduce emission of EMI in the pixel. An electric current flows into the X electrode 310 from left to right. Accordingly, among the X electrode 310, the electric current flows into both boundaries of each pixel in opposite directions. Therefore, a magnetic field generated by an electric current on one side flowing in a certain direction offsets a magnetic field generated by an electric current on the other side flowing in the opposite direction, so EMI can be reduced.

For example, in pixel G of FIG. 3A, a portion of the X electrode 310 which is formed inside pixel G and a portion of a Y electrode (not shown) which is formed inside pixel G facing the X electrode 310 are used for plasma discharge. In addition, a portion of the X electrode 310 which is formed on the left boundary of pixel G, and a portion of the X electrode 310 which is formed on the right boundary of pixel G have opposite current directions with respect to each other, so magnetic fields generated by the two currents cancel each other.

As described above, a pattern in which the X electrode 310 horizontally goes through the inside of a pixel and vertically goes through the boundary of the pixel is repeated, to form a prominence and depression structure. Therefore, offset of EMI is repeated, and emission of EMI on the display panel 240 can be reduced.

FIG. 3B illustrates the form of the Y electrode 320 in the same row of pixels as illustrated in FIG. 3A from among the plurality of pixels.

As in the X electrode 310, the Y electrode 320 horizontally goes through the pixels in a single row. That is, a pattern in which the Y electrode 320 horizontally goes through the inside of each pixel, and vertically goes through the boundary of each pixel is repeated, thereby forming a prominence and depression structure.

As described above, the X electrode 310 faces the Y electrode 320, with discharging space therebetween. In a pixel in which the X electrode 310 is disposed on the upper side of the discharging space, the Y electrode 320 is disposed on the lower side of the discharging space. Alternatively, in a pixel in which the X electrode 310 is disposed on the lower side of the discharging space, the Y electrode 320 is disposed on the upper side of the discharging space.

In addition, as in the X electrode 310, a portion of the Y electrode 320 formed on the boundary of each pixel is used to reduce emission of EMI in the pixel.

That is, an electric current flows into the Y electrode 320 from right to left. Accordingly, among the Y electrode 320, the electric current flows into both boundaries of each pixel in opposite directions. Therefore, a magnetic field generated by an electric current on one side of a pixel flowing in a certain direction offsets a magnetic field generated by an electric current on the other side of the pixel flowing in the opposite direction, so EMI can be reduced.

As described above, as in the X electrode 310, a pattern in which the Y electrode 320 horizontally goes through the inside of a pixel and vertically goes through the boundary of the pixel is repeated, to form a prominence and depression structure. Therefore, offset of EMI is repeated, and emission of EMI on the display panel 240 can be reduced.

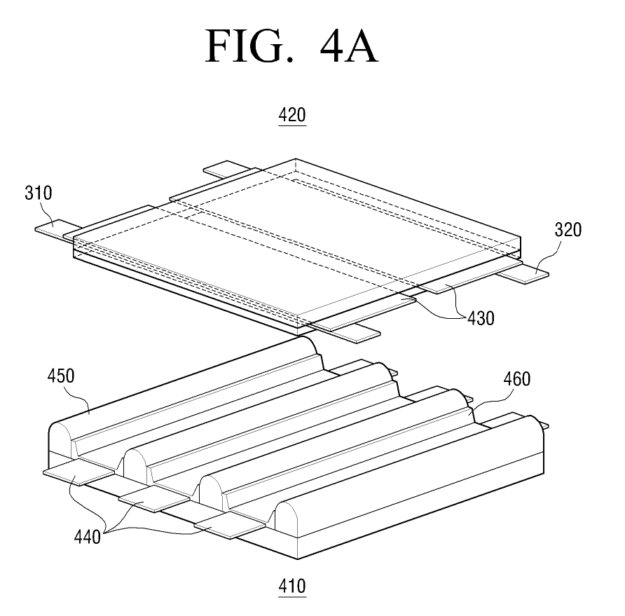

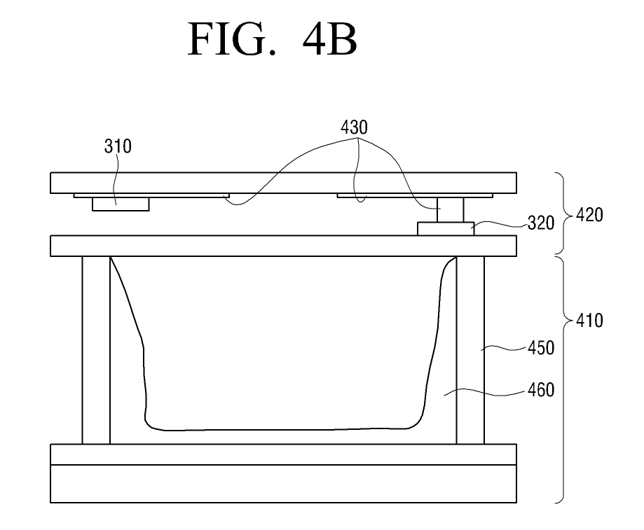

In the same row, both the X electrode 310 and the Y electrode 320 are formed on the boundary of each pixel as can be easily shown by superimposing FIG. 3A and FIG. 3B. In this case, to normally perform plasma discharge, the X electrode 310 and the Y electrode 320 should not be electrically connected on the boundary of each pixel. Hereinafter, a structure that prevents electrically connecting the X electrode 310 and the Y electrode 320 is described with reference to FIGS. 4A and 4B.

FIGS. 4A and 4B illustrate an internal structure of a pixel. In particular, FIG. 4A illustrates a partially exploded perspective view of the display panel 240, showing only three pixels (pixel R, pixel G, and pixel B) from among the plurality of pixels on the display panel 240.

The display panel 240 consists of a lower panel 410 and an upper panel 420.

The lower panel 410 includes an address electrode 440, a partition 450, and a fluorescent substance 460. The address electrode 440 is disposed between each partition 450, and the fluorescent substance 460 is applied on the upper surface of the address electrode 440. The partition 450 cuts off the fluorescent substance 460 applied on the upper surface of the address electrode 440, so pixel R, pixel G, and pixel B can be distinguished.

The upper panel 410 includes an X electrode 310, a Y electrode 320, and indium tin oxide (ITO) electrode 430. The ITO electrode 430 is disposed on the X electrode 310 so as to be electrically connected with the X electrode 310, and is disposed on the Y electrode 320 so as to be electrically connected with the Y electrode 320. That is, the ITO electrode 430 includes a portion to be electrically connected with the X electrode 310, and a portion to be electrically connected with the Y electrode 320.

The ITO electrode 430 is a kind of transparent electrode which is used to prevent light generated between the X electrode 310 and the Y electrode 320 from being shown by hiding the opaque X electrode 310 and Y electrode 320.

In order for the X electrode 310 and the Y electrode 320 not to be electrically connected, the X electrode 310 and the Y electrode 320 are formed on the display panel 240 to have different heights. Detailed description is given with reference to FIG. 4B.

FIG. 4B illustrates a sectional view of a single pixel from among the plurality of pixels on the display panel 240. Since the partition 450 and the fluorescent substance 460 on the lower panel 410, and the X electrode 310, the Y electrode 320, and the ITO electrode 430 on the upper panel 420 have been described in detail in FIG. 4A, only the structure of the X electrode 310, the Y electrode 320, and the ITO electrode 430 is described here.

As described above, the X electrode 310 and the Y electrode 320 flow into the boundary of each pixel, and should not be electrically connected with each other. In addition, the X electrode 310 and the ITO electrode 430 around the X electrode 310 should be electrically connected with each other, and the Y electrode 320 and the ITO electrode 430 around the Y electrode 320 should be electrically connected with each other.

To satisfy these conditions, the ITO electrode 430 which is around the Y electrode 320 lower than the X electrode 310 and is electrically connected with the Y electrode 320 extends downwards compared with the ITO electrode 430 around the X electrode 310.

Therefore, even if the structure of the electrodes to reduce EMI emission can be maintained, the X electrode 310 and the Y electrode 320 flowing into the boundary of each pixel cannot be electrically connected with each other. Furthermore, even if the structure of the electrodes to reduce EMI emission can be maintained, the X electrode 310 and the ITO electrode 430 around the X electrode 310 can be electrically connected with each other, and the Y electrode 320 and the ITO electrode 430 around the Y electrode 320 can be electrically connected with each other.

Up to now, the structure of the electrodes to reduce EMI emission can be maintained by extending the ITO electrode 430 around the Y electrode 320 downwards, but this is merely an example for convenience of description. The structure of the electrodes to reduce EMI emission can be maintained by extending the Y electrode 320 upwards instead of extending the ITO electrode 430 around the Y electrode 320 downwards.

Furthermore, when forming the X electrode 310 and the Y electrode 320 to have different heights, the X electrode 310 is formed higher than the Y electrode 320, but this is merely an example for convenience of description. The technical idea of the exemplary embodiment can be applied even when the Y electrode 320 is formed higher than the X electrode 310.

In this case, contrary to the case in which the X electrode 310 is formed higher than the Y electrode 320, the structure of the electrodes to reduce EMI emission can be maintained by extending the ITO electrode 430 around the X electrode 310 downwards, or by extending the X electrode 310 upwards.

In FIGS. 3A and 3B, the example form of the X electrode 310 and the Y electrode 320 to reduce EMI emission is illustrated, but the form of the X electrode 310 and the Y electrode 320 is not limited thereto. The technical idea of the exemplary embodiment can be applied if EMI emission is reduced by forming the X electrode 310 and the Y electrode 320 on at least one of the pixels in a first direction and a second direction alternately, by passing the X electrode 310 and the Y electrode 320 through the inside and the boundary of at least one pixel, or by forming the X electrode 310 and the Y electrode 320 in a prominence and depression structure.

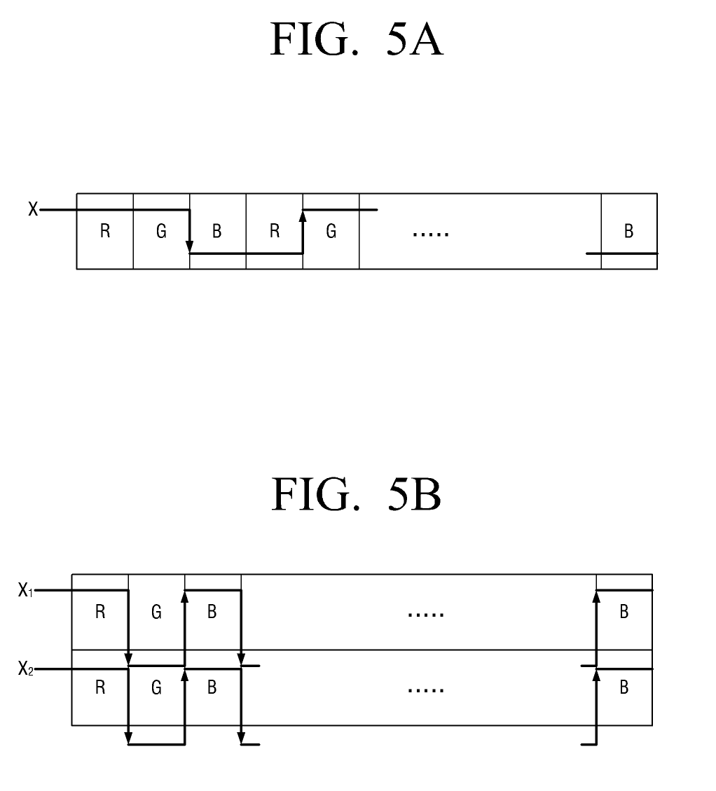

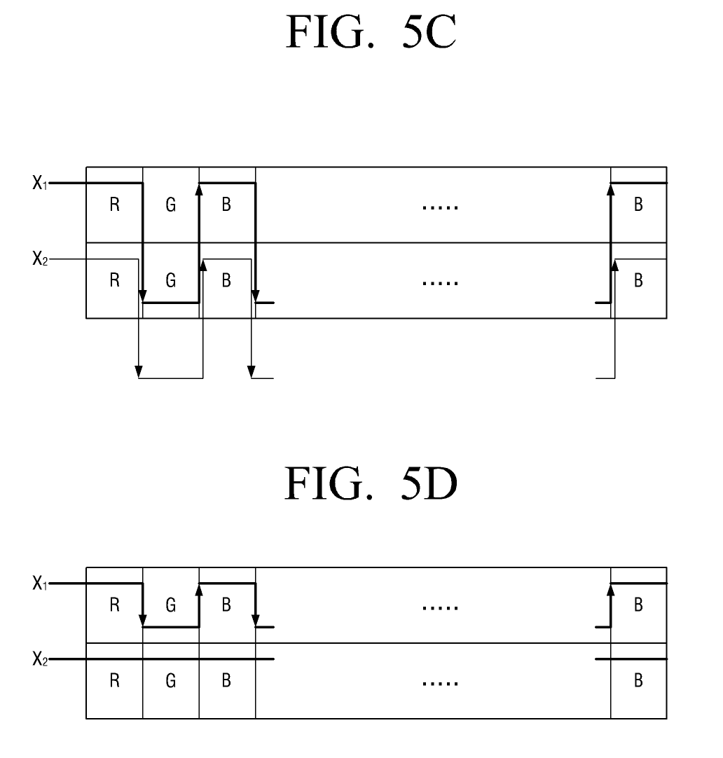

Hereinafter, other forms of the electrodes to which the technical idea of the present invention can be applied are described with reference to FIGS. 5A to 5D.

FIGS. 5A to 5D illustrate the forms of an X electrode according to diverse exemplary embodiments of the present invention.

FIG. 5A illustrates the pixels in a single row on the display panel 240, and the form of an X electrode formed on the pixels. As illustrated in FIG. 5A, the X electrode is formed such that it goes through two horizontally adjacent pixels horizontally, and goes through the boundary of the next pixel vertically, in an alternating manner. Accordingly, the X electrode is formed in a prominence and depression structure, so EMI emission can be reduced.

FIG. 5B illustrates the pixels in two rows on the display panel 240, and the form of two X electrodes (X₁ electrode and X₂ electrode) formed on the pixels. The two X electrodes are formed at the upper portion of the upper row and the lower row, respectively, with reference to a discharging space of the pixel. In addition, the two X electrodes are formed such that each X electrode horizontally goes through the inside of a first pixel at the upper portion thereof, vertically goes through the boundary of the first pixel and a second pixel that is vertically adjacent to the first pixel, and horizontally goes through the inside of a third pixel that is horizontally adjacent to the second pixel at the upper portion of the third pixel. Accordingly, the X electrode is formed in a prominence and depression structure, so EMI emission can be reduced.

FIG. 5C illustrates the pixels in two rows on the display panel 240, and two X electrodes (X₁ electrode and X₂ electrode) formed on the pixels. As illustrated in FIG. 5C, the two X electrodes are formed such that each X electrode horizontally goes through the inside of a first pixel at the upper portion thereof, vertically goes through the boundary of the first pixel and a second pixel that is vertically adjacent to the first pixel, and horizontally goes through the inside of a third pixel, which is horizontally adjacent to the second pixel, at the lower portion of the third pixel. The difference between FIG. 5B and 5C is that in FIG. 5C, each X electrode is formed at the upper portion of the upper row and is formed at the lower portion of the lower row with reference to a discharging space of the pixel. If the X₁ electrode and the X₂ electrode are formed in this manner, the X₁ electrode and the X₂ electrode may be electrically connected at the boundary of each pixel, aside from the Y electrode (not shown). To prevent this problem, the X₁ electrode and the X₂ electrode may have different heights.

FIG. 5D illustrates the pixels in two rows on the display panel 240, and two X electrodes (X₁ electrode and X₂ electrode) formed on the pixels. Among the two X electrodes, the X₁ electrode is formed such that it goes through the inside of every single pixel of the top row of pixels horizontally and goes through the boundary of every single pixel of the top row of pixels vertically, in an alternating manner. On the other hand, the X₂ electrode is formed in a straight line that passes through the inside of every pixel in the bottom row of pixels. The technical idea of the exemplary embodiment can be applied to the case that the display panel 240 is formed by using the X₁ electrode in a prominence and depression structure and the X₂ electrode in a straight line.

For convenience of description, the Y electrode is not illustrated. However, also in FIGS. 5A to 5D, the Y electrode may face the X electrode in a discharging space as illustrated in FIGS. 3A and 3B.

As described above, the X electrode and the Y electrode are formed on at least one of the pixels on the display panel 240 in a first direction and a second direction in an alternating manner, go through the inside and the boundary of the at least one pixel, or are formed in a prominence and depression structure. The address electrode may be formed in the same manner.

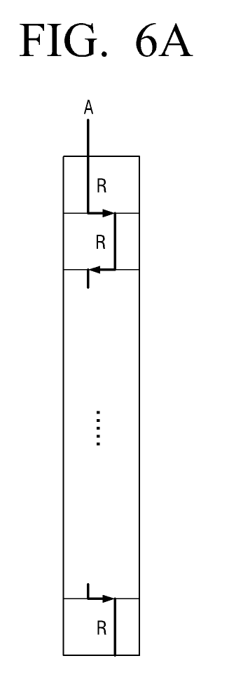

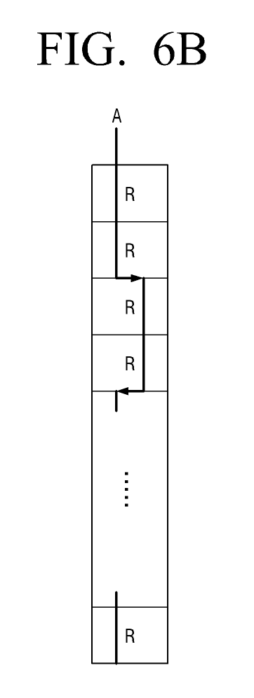

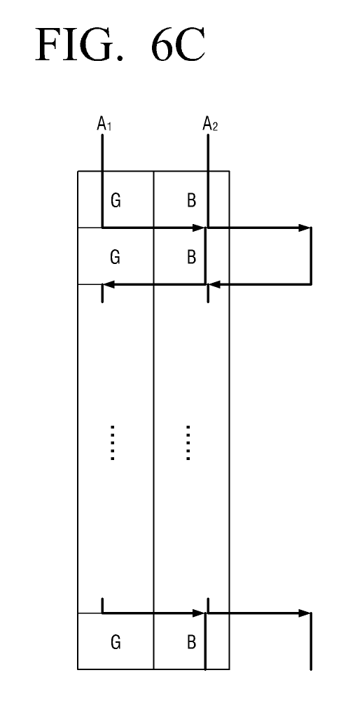

Hereinafter, the form of the address electrode according several exemplary embodiments is described with reference to FIGS. 6A to 6C.

FIG. 6A illustrates the pixels in a single column, and the form of an address electrode formed on the pixels. As illustrated in FIG. 6A, the address electrode goes through the inside of the pixel vertically and goes through each boundary in alternating horizontal directions. When the address electrode is vertically formed, the address electrode goes through the inside of the pixels, and when the address electrode is horizontally formed, the address electrode goes through the boundary of the pixels. Accordingly, the address electrode is formed in aprominence and depression structure, and since magnetic fields are offset in portions in which the address electrode is horizontally formed, EMI emission can be reduced.

FIG. 6B illustrates the pixels in a single column on the display panel 240, and the form of an address electrode formed on the pixels. As illustrated in FIG. 6B, the address electrode is formed vertically and horizontally in an alternating manner on every two pixels of the pixels in a single vertical column. The address electrode vertically goes through the inside of every two vertically adjacent pixels, and horizontally goes through the boundary of every other pixel in alternating horizontal directions. Accordingly, the address electrode is formed in a prominence and depression structure, so EMI emission can be reduced due to offset of a magnetic field on portions in which the address electrode is horizontally formed.

FIG. 6C illustrates the pixels in two columns on the display panel 240, and two address electrodes formed on the pixels. As illustrated in FIG. 6C, each address electrode is formed vertically and horizontally in an alternating manner on every two pixels of the pixels in two columns. Each address electrode vertically goes through the inside of a first pixel, horizontally goes through the boundary of the first pixel and a second pixel that is horizontally adjacent to the first pixel, vertically goes through the inside of a third pixel that is vertically adjacent to the second pixel, and horizontally goes through the boundary of the third pixel and a fourth pixel that is vertically adjacent to the first pixel. Accordingly, the address electrode is formed in a prominence and depression structure, so EMI emission can be reduced due to offset of a magnetic field on portions in which the address electrode is horizontally formed.

The forms of the electrode as described above are merely part of diverse forms of the electrode. Accordingly, if the X electrode, the Y electrode, or the address electrode is formed on at least one of the pixels on the display panel 240 in a first direction and a second direction in an alternating manner, go through the inside and the boundary of the at least one pixel, or are formed in a prominence and depression structure, the technical idea of the exemplary embodiments can be applied to the X electrode, the Y electrode, or the address electrode.

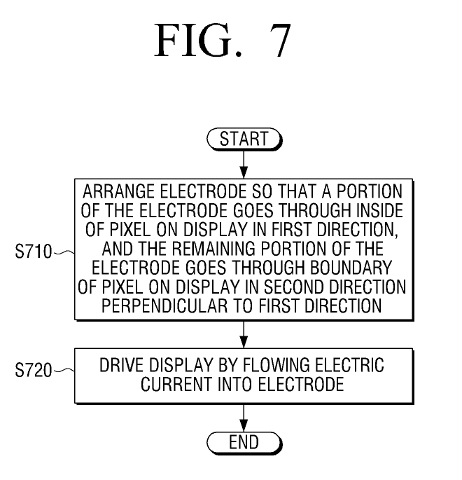

FIG. 7 is a flow chart illustrating a method for operating a display according to an exemplary embodiment.

To operate the display, the electrode is disposed so that a portion of the electrode goes through the inside of a pixel on the display in a first direction, and the remaining portion of the electrode goes through the boundary of the pixel on the display in a second direction perpendicular to the first direction (S710).

Subsequently, the display is operated by flowing the electric current into the electrode (S720).

As described above, emission level of EMI generated by a discharge electrode of the display can be reduced by forming the electrode on the pixels in a first direction and a second direction alternately, by passing the electrode through the inside and the boundary of the pixels, thereby forming the electrode in a prominence and depression structure.

Therefore, emission level of EMI generated by a discharge electrode of a PDP panel can be reduced.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display panel, comprising:
a plurality of pixels; and
an electrode disposed on the plurality of pixels in a first direction and a second direction in an alternating manner.

2. The display panel according to claim 1, wherein the electrode is disposed on pixels of a same row or a same column from among the plurality of pixels.

3. The display panel according to claim 1, wherein the electrode comprises a plurality of portions disposed in the first direction, and a plurality of portions disposed in the second direction,
wherein when an electric current is applied to the electrode, the electric current in the plurality of portions disposed in the first direction flows in a first current direction, the electric current in a first electrode portion disposed in the second direction flows in a second current direction, and the electric current in a second electrode portion disposed in the second direction flows in a third current direction; and
wherein the second current direction is opposite from the third current direction.

4. The display panel according to claim 3, wherein the first electrode portion disposed in the second direction and the second electrode portion disposed in the second direction are adjacent portions of the plurality of portions disposed in the second direction.

5. The display panel according to claim 3, wherein the first electrode portion disposed in the second direction is disposed through a first boundary of a first pixel of the plurality of pixels, and the second electrode portion disposed in the second direction is disposed through a second boundary of the first pixel.

6. The display panel according to claim 3, wherein the first current direction is perpendicular to the second current direction and the third current direction.

7. The display panel according to claim 1, wherein the electrode is disposed through an inside of a first pixel of the plurality of pixels in the first direction, and is disposed through a boundary of the first pixel in the second direction.

8. The display panel according to claim 7, wherein the first direction is perpendicular to the second direction.

9. The display panel according to claim 7, wherein the electrode is disposed through a first boundary and a second boundary of the first pixel in the second direction.

10. The display panel according to claim 9, wherein when an electric current is applied to the electrode, the electric current flows through the first boundary in a first current direction, and the electric current flows through the second boundary in a second current direction;
wherein the first current direction is opposite from the second current direction.

11. The display panel according to claim 1, wherein the electrode comprises at least one of an X electrode, a Y electrode, and an address electrode,
wherein, if the electrode is the X electrode or the Y electrode, the first direction is a row direction of the plurality of pixels, and the second direction is a column direction of the plurality of pixels, and
wherein, if the electrode is the address electrode, the first direction is a column direction of the plurality of pixels, and the second direction is a row direction of the plurality of pixels.

12. The display panel according to claim 1, wherein the electrode comprises an X electrode and a Y electrode, and
a portion of the X electrode and a portion of the Y electrode have different heights with reference to a plane on which the plurality of pixels are located.

13. The display panel according to claim 1, wherein the electrode comprises an X electrode, a Y electrode, an indium tin oxide (ITO) electrode connected to the X electrode, and an ITO electrode connected to the Y electrode,
wherein the ITO electrode connected to the X electrode and the ITO electrode connected to the Y electrode have the same height with reference to a plane on which the plurality of pixels are located.

14. The display panel according to claim 1, wherein the electrode comprises an X electrode,
wherein a number of portions of the X electrode disposed in the first direction is equal to a number of rows of the plurality of pixels.

15. The display panel according to claim 1, wherein the electrode comprises a Y electrode,
wherein a number of portions of the Y electrode disposed in the second direction is equal to a number of columns of the plurality of pixels.

16. The display panel according to claim 1, wherein the electrode comprises at least one of an X electrode, a Y electrode, and an address electrode,
wherein a number of X electrodes or Y electrodes equals a number of rows of the plurality of pixels.

17. The display panel according to claim 1, wherein the electrode comprises at least one of an X electrode, a Y electrode, and an address electrode,
wherein a number of address electrodes equals a number of columns of the plurality of pixels.

18. The display panel according to claim 1, wherein the electrode comprises an X electrode and a Y electrode that face each other in an inside of each pixel of the plurality of pixels;
wherein the display panel further comprises a discharge space between the X electrode and the Y electrode in each pixel of the plurality of pixels.

19. The display panel according to claim 1, wherein the electrode comprises an X electrode or a Y electrode,
wherein for each pixel of the plurality of pixels, the X electrode is disposed on a first side of a discharge space, and the Y electrode is disposed on a second side of the discharge space.

20. A display panel, comprising:
a plurality of pixels; and
an electrode disposed through an inside of at least one of the plurality of pixels and a boundary of at least one of the plurality of pixels.

21. The display panel according to claim 20, wherein the electrode goes through an inside of a first pixel, goes through an inside of a second pixel which is adjacent to the first pixel, and goes through a boundary of the second pixel which is opposite the first pixel.

22. The display panel according to claim 20, wherein the plurality of pixels comprises a first pixel, a second pixel horizontally adjacent to the first pixel, and a third pixel vertically adjacent to the second pixel;
wherein the electrode is disposed through an inside of the first pixel, through a boundary between the first pixel and second pixel, and through an inside of the third pixel.

23. The display panel according to claim 22, wherein the electrode is disposed through an upper portion of the inside of the first pixel, and through a lower portion of the third pixel.

24. The display panel according to claim 20, wherein the plurality of pixels comprises a first row of pixels and a second row of pixels;
wherein the electrode comprises a first electrode disposed on the first row of pixels in a first direction and a second direction in an alternating manner, and a second electrode disposed on the second row of pixels in the first direction.

25. A display driving apparatus, comprising:
a display panel comprising an electrode disposed on at least one of a plurality of pixels in a first direction and a second direction in an alternating manner; and
a driving unit which drives the display panel to cause plasma discharge in the plurality of pixels.

26. A display apparatus, comprising:
a display panel comprising an electrode disposed on a plurality of pixels in a first direction and a second direction in an alternating manner; and
a control unit which controls driving of the display panel to cause plasma discharge in the plurality of pixels.

27. A method for driving a display, the method comprising:
arranging an electrode so that a first portion of the electrode is disposed in a first direction inside at least one of a plurality of pixels provided on the display, and a second portion of the electrode is disposed on a boundary of the at least one pixel in a second direction perpendicular to the first direction; and
driving the display by flowing an electric current into the electrode.
